(19) United States
(12) Patent Application Publication
(10) Pub. No.: US 2019/0387107 A1
(43) Pub. Date: Dec. 19, 2019

(54) IMAGE PROCESSING DEVICE, SELF-DIAGNOSTIC METHOD AND NON-TRANSITORY RECORDING MEDIUM

(71) Applicant: Konica Minolta, Inc., Tokyo (JP)

(72) Inventor: Satoshi Uchino, Toyokawa-shi (JP)

(73) Assignee: Konica Minolta, Inc., Tokyo (JP)

(21) Appl. No.: 16/428,342

(22) Filed: May 31, 2019

(30) Foreign Application Priority Data
Jun. 19, 2018 (JP) 2018-115812

(51) Int. Cl. H04N 1/00; G06F 3/12; H04N 1/04

(52) U.S. Cl. CPC H04N 1/00167; H04N 1/04; G06F 3/1237

(57) ABSTRACT

An image processing device that has a normal job mode and a reproducing and verifying mode includes: a hardware processor that: receives a job; controls processing of the received job in the normal job mode; generates job details information relating to the received job to be processed, when a problem occurs during processing of the job, adds a problem code corresponding to the problem to the job details information to manage the job details information; shifts to the reproducing and verifying mode from the normal job mode only if the problem code is added to the job details information; and generates a reproduced job based on the job details information added with the problem code and controls processing of the reproduced job in the reproducing and verifying mode.

### CROSS-REFERENCE TO RELATED APPLICATIONS

Japanese patent application No. 2018-115812 filed on Jun. 19, 2018 including description, claims, drawings, and abstract the entire disclosure is incorporated herein by reference in its entirety.

### BACKGROUND

### Technical Field

The present invention relates to an image processing device, a self-diagnostic method and a non-transitory recording medium. The present invention more specifically relates to a self-diagnostic technique when a trouble (problem) occurs in the image processing device.

### Description of the Related Art

When a trouble occurs during processing of a job such as a copy job, a conventional image processing device which is one of so called MFPs (Multifunctional Peripherals) stores information relating to the job in a non-volatility storage area so that a service person is enabled to see the information later. This known technique is introduced for example in Japanese Patent Application Laid-Open No. JP H5-197234 A. According to the known technique, the information stored at the occurrence of the trouble is about a copy mode (2-sided or 1-sided), magnification data, and/or a used cassette, for example. This information, however, cannot be useful information for resolving an occurrence reason of the trouble.

There are also reproduction systems capable of automatically reproducing troubles for investigations of the troubles occurred in client environments. This known technique is introduced for example in Japanese Patent Application Laid-Open No. JP 2010-256997 A. According to the known technique, the reproduction system converts structure information of hardware and software of users into a form that enables a hardware emulator to interpret and outputs as a structure file. Also, the reproduction system obtains information as to a hard error including internal log routine which was executed at detection of the hard error from log information obtained from the users and outputs the information as to the hard error as a scenario file. The reproduction system boots the hardware emulator based on the structure file, and sends an operation instruction to a developer hard management soft and an instruction on the occurrence of the hardware to the hardware emulator based on the scenario file.

The conventional reproduction system, however, operates the hardware emulator based on the hardware of the users and structure information of the software to enable reproduction of a cause of the occurrence of the trouble on the hardware emulator. The conventional reproduction system does not reproduce the cause of the occurrence of the trouble using a device in which the trouble actually occurs. It, therefore, is difficult for the conventional reproduction system to reproduce a unique trouble occurs in an image processing device which is installed in the client environment and that is having a low occurrence rate. Especially, when the trouble occurs due to external causes unique to the client environment (for example, temperature, humidity, power condition and/or surrounding electrostatic environment), the conventional reproduction system is not capable of clearing up the cause of the trouble.

Even when the trouble occurs in the image processing device, the trouble may be resolved by rebooting the image processing device, and the image processing device may return to a state that is enabled to process a job. Even though the cause of the trouble is not cleared up, the user is allowed to keep using the image processing device by rebooting the image processing device. In such a case, if the image processing device is occupied for a long time for clearing up the cause of the trouble, the user is not allowed to use the image processing device, resulting in reduction in convenience.

### SUMMARY

One or more embodiments of the present invention provide an image processing device, a self-diagnostic method and a non-transitory recording medium capable of reproducing an occurrence of a trouble (problem) in a state of installation in a client environment and clearing up a cause of the trouble in an early period.

First, one or more embodiments of the present invention are directed to an image processing device that has a normal job mode and a reproducing and verifying mode.

The image processing device according to one or more embodiments of the present invention comprises: a hardware processor that: receives a job; controls processing of the received job in said normal job mode; generates job details information relating to the job to be processed, and adds a trouble code corresponding to a trouble to said job details information to manage when the trouble occurs during processing of the job; shifts to said reproducing and verifying mode from said normal job mode only if the trouble code is added to said job details information; and generates a reproduced job based on said job details information to which the trouble code is added and controls processing of said reproduced job in said reproducing and verifying mode.

Second, one or more embodiments of the present invention are directed to a self-diagnostic method applied at an image processing device.

The self-diagnostic method according to one or more embodiments of the present invention comprises the steps of: receiving a job; controlling processing of the received job in a normal job mode; generating job details information relating to the job to be processed, and adding a trouble code corresponding to a trouble to said job details information to manage when the trouble occurs during processing of the job; shifting to a reproducing and verifying mode from said normal job mode only if the trouble code is added to said job details information; and generating a reproduced job based on said job details information to which the trouble code is added and controlling processing of said reproduced job in said reproducing and verifying mode.

Third, one or more embodiments of the present invention are directed to a non-transitory recording medium storing a computer readable program to be executed by a hardware processor in an image processing device having a normal job mode and a reproducing and verifying mode.

The non-transitory recording medium according to one or more embodiments of the present invention stores the computer readable program, execution of the computer readable program by the hardware processor in the image processing device causing the hardware processor to perform: receives a job; controls processing of the received job in said normal job mode; generates job details information relating to the job to be processed, and adds a trouble code corresponding to a trouble to said job details information to manage when the trouble occurs during processing of the job; shifts to said reproducing and verifying mode from said normal job mode only if the trouble code is added to said job details information; and generates a reproduced job based on said job details information to which the trouble code is added and controls processing of said reproduced job in said reproducing and verifying mode.

### BRIEF DESCRIPTION OF THE DRAWING

The advantages and features provided by one or more embodiments of the invention will become more fully understood from the detailed description given herein below and the appended drawings which are given by way of illustration only, and thus are not intended as a definition of the limits of the present invention.

FIG. 1 illustrates an exemplary configuration of an image processing system according to one or more embodiments;

FIG. 2 illustrates a block diagram showing an example of a hardware structure of an image processing device according to one or more embodiments;

FIG. 3 illustrates an example of a functional structure of a controller according to one or more embodiments;

FIGS. 4A and 4B illustrate an example of job details information according to one or more embodiments;

FIG. 5 illustrates an example of table information according to one or more embodiments;

FIG. 6 illustrates a block diagram showing an example of a detailed functional structure of a reproduced job controller according to one or more embodiments;

FIGS. 7A, 7B and 7C illustrate input and output timings of a control signal according to one or more embodiments;

FIG. 8 illustrates a flow diagram explaining an exemplary procedure of a main process performed at the image processing device according to one or more embodiments;

FIG. 9 illustrates a flow diagram explaining in detail an exemplary procedure of a normal job controlling process according to one or more embodiments; and

FIG. 10 illustrates a flow diagram explaining in detail an exemplary procedure of a reproduced job controlling process according to one or more embodiments.

### DETAILED DESCRIPTION

Hereinafter, embodiments of the present invention will be described with reference to the drawings. However, the scope of the invention is not limited to the disclosed embodiments.

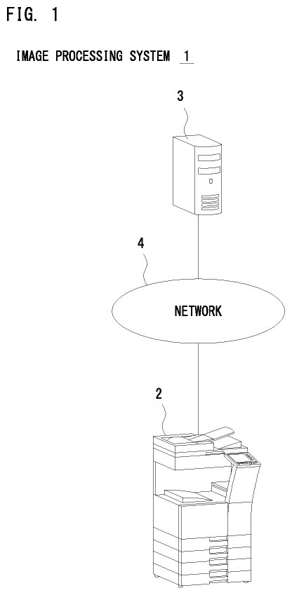

FIG. 1 illustrates an exemplary configuration of an image processing system 1 in which one or more embodiments of the present invention may be practiced. The image processing system 1 includes an image processing device 2 and a server 3 connected to each other to enable communication between each other over a network 4. The image processing device 2 is installed in a local environment of a user, for example. The network 4 includes a large area network such as a local network like LAN (Local Area Network) and/or an internet. The server 3 is installed on a cloud on the internet, for example. The server 3 is enabled to communicate with the image processing devices 2 installed in various places all over the world.

The image processing device 2 may be one of MFPs, for example, including multiple functions such as a scan function, a print function and/or a fax function. The image processing device 2 activates the function corresponding to a type of a job specified by the user and processes various types of jobs including scan jobs, print jobs, copy jobs and fax jobs. In response to receiving the print job over the network 4, for example, the image processing device 2 processes the print job and produces a printed output.

The image processing device 2 has two modes, a normal job mode and a reproducing and verifying mode, as its operation mode. In the normal job mode, the image processing device 2 processes the job given by the user, and in the reproducing and verifying mode, the image processing device 2 reproduces and verifies a trouble (problem) when the trouble occurs.

Once the image processing device 2's power switch is turned on, the image processing device 2 normally boots in the normal job mode. In the normal job mode, the normal jobs (such as scan jobs, print jobs, copy jobs and fax jobs) given by the user are processed. After the image processing device 2 in the normal job mode receives the job given by the user, it generates job details information corresponding to the received job and stores the generated job details information in a non-volatility storage device. The job details information is used for reproducing the trouble when the trouble occurs during the processing of the job.

The trouble such as a hardware error and/or a software error may occur during the processing of the job in the normal job mode. In such a case, the image processing device 2 adds a trouble code (problem code) corresponding to the trouble to the job details information. When the image processing device 2 in the normal job mode is not used by the user for more than a predetermined period of time, it shifts the operation mode to the reproducing and verifying mode only if the trouble code is added to the job details information.

The reproducing and verifying mode enables reproduction of the trouble occurred in the image processing device 2 to perform a self-diagnostic. When shifting to the reproducing and verifying mode, the image processing device 2 generates a reproduced job corresponding to the job processed at the occurrence of the trouble based on the job details information to which the trouble code is added. The image processing device in the reproducing and verifying mode processes the reproduced job so that verifies that the same trouble occurs again.

The same trouble may not occur again in the image processing device 2 with the processing of the reproduced job just for once. The trouble may have a low occurrence rate that accidentally occurs due to an external cause (for example, temperature, humidity, power condition and/or surrounding electrostatic environment) of the environment in which the image processing device 2 is installed. In this case, the same trouble does not occur even if the reproduced job is processed without satisfaction of the same external cause. The image processing device 2 in the reproducing and verifying mode repeatedly processes the reproduced job until confirming the same trouble has occurred again. For repeatedly processing the reproduced job, the image processing device 2 may process the reproduced job under the same conditions as the last time or may process the reproduced job under the different conditions from the last time.

When processing the reproduced job in the reproducing and verifying mode, the image processing device 2 records detailed log and generates log information. When confirming the occurrence of the same trouble in response to the processing of the reproduced job, the image processing device 2 sends the log information to the server 3.

The server 3 collects the log information generated at the occurrence of the trouble from the image processing devices 2 installed in various places. The log information collected by the server 3 is analyzed so that the cause of the trouble occurs in a low frequency in the image processing device 2 may be cleared up. It may be determined that the certain hardware or the software of the image processing device 2 may be the cause of the occurrence of the trouble, for example. In such a case, the cause is fed back to a hardware design and/or a software design so that the hardware and/or the software may be improved. If the cause of the trouble of a low occurrence frequency occurs in the image processing device 2 can be cleared up, the service person can be dispatched to the installation site of the image processing device 2 and appropriate repairing work can be done.

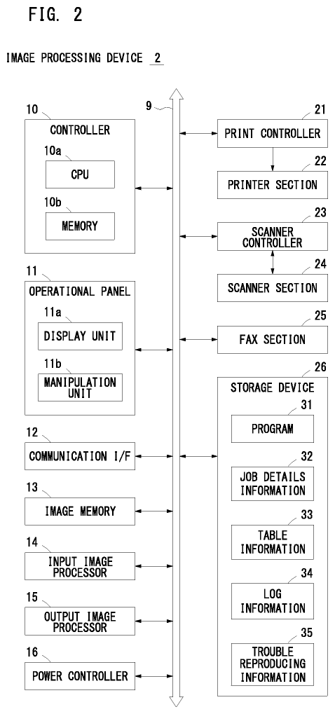

The details of the image processing device 2 is explained next. FIG. 2 illustrates a block diagram showing an example of a hardware structure of the image processing device 2 according to one or more embodiments. As its hardware structure, the image processing device 2 includes a controller 10, an operational panel 11, a communication interface 12, an image memory 13, an input image processor 14, an output image processor 15, a power controller 16, a print controller 21, a printer section (printer) 22, a scanner controller 23, a scanner section (scanner) 24, a fax section 25 and a storage device 26. Each of the parts is enabled to input and output data to and from each other via a bus 9.

The controller 10 including a CPU 10a and a memory 10b controls overall operations of each part. The CPU 10a reads and executes a program 31 stored in the storage device 26. Data, for instance, used when the CPU 10a processes processing based on the program 31 is temporarily stored in the memory 10b.

The operational panel 11 serves as a user interface for the user to use the image processing device 2. The operational panel 11 includes a display unit 11a that displays a variety of screens operable for the user and a manipulation unit 11b that receives user inputs. The user uses the operational panel 11 to give a job setting operation and/or a job processing instruction.

The communication interface 12 is an interface that connects the image processing device 2 to the network 4. The image processing device 2 communicates with other devices connected to the network 4 via the communication interface 12. The image processing device 2, for example, is enabled to receive the print job via the communication interface 12. The image processing device 2 is also enabled to send the log information to the server 3 via the communication interface 12.

The image memory 13 is a memory in which image data obtained during the processing of the job is temporarily stored. To be more specific, the image data generated in response to processing of the job and/or the image data obtained at receipt of the job is stored in the memory 13, for example. When the job is the scan job, for instance, the image data generated by reading a document is stored, and when the job is the print job, for instance, the image data included in the print job is stored in the image memory 13.

The input image processor 14 applies an image processing to the input image data. For the scan job, for instance, the input image processor 14 reads the image data stored in the image memory 13 in response to the scan job, and applies a variety of image processing including color conversion, resolution conversion and image compression based on scan settings to the image data. The input image processor 14 then stores the image data to which the image processing is applied again in the image memory 13.

The output image processor 15 applies an image processing to the output image data. For the print job, for instance, the output image processor 15 reads the image data stored in the image memory 13, and applies a variety of image processing including image expansion, resolution conversion, color conversion, size conversion and image rotation based on print settings to the image data. The output image processor 15 then stores the image data to which the image processing is applied again in the image memory 13.

The power controller 16 controls power state of the image processing device 2. When the image processing device 2 in the normal job mode is not used by the user for more than the predetermined period of time, for example, the power controller 16 controls to shift the power state of the image processing device 2 to a power saving state from the normal power state. The image processing device 2 in the reproducing and verifying mode is required to process the reproduced job even if it has not been used by the user. Thus, in one or more embodiments, the power controller 16 does not shift the power state to the power saving state when the image processing device 2 is in the reproducing and verifying mode. While the power state is shifted to the power saving state, the communication interface 12 may receive the print job or the operational panel 11 may detect the user operation. In such a case, the power controller 16 returns the power state of the image processing device 2 to the normal power state from the power saving state.

The power controller 16 is also enabled to automatically reboot the image processing device 2 based on an instruction from the controller 10. The controller 10 may output a reboot instruction when the trouble occurs in the image processing device 2, for example. The power controller 16 then starts a rebooting process of the image processing device 2 based on the reboot instruction. Thus, the image processing device 2 automatically reboots. The trouble may be resolved as a result of the reboot, and the image processing device 2 may be back to the state that enables the processing of the job again.

The print controller 21 controls the printer section 22. The printer section 22 forms images on a printing sheet in electrophotography and produces a printed output, for example. The printer section 22 includes operation parts including an electrification device, a photoreceptor drum, an exposure device, a developing device, a transfer mechanism and a fixing device. The print controller 21 drives each of the operation parts provided with the printer section 22 to control operations to produce printed outputs. The print controller 21, for example, reads the image data in the image memory 13, and controls the printer section 22 based on the image data so that a printed output is enabled to be produced based on the image data.

The scanner controller 23 controls the scanner section 24. The scanner section 24 optically reads an image of a document and generates the image data. The scanner section 24 includes an operation part that enables a linear reading head arranged along a main scanning direction to move in a vertical scanning direction. The scanner controller 23 drives the operation part provided with the scanner section 24 to connect the linear image data output from the reading head one after another in the vertical scanning direction. Two-dimensional image data corresponding to the image of the document can then be generated. The scanner controller 23 stores the image data in the image memory 13.

The fax section 25 transmits and receives fax data over public phone lines not shown in figures. In response to receiving fax data over the public phone line, for example, the fax section 25 converts the received fax data into image data and stores the image data in the image memory 13. When sending the fax data, the fax section 25 reads the image data stored in the image memory 13 and converts the read image data into fax data. The fax section 25 then sends the fax data to a designated address over the public phone line.

The storage device 26 is formed from a non-volatility storage device such as a hard disk drive (HDD), for example. The program 31 executed by the CPU 10a of the controller 10 is stored in advance in the storage device 26. Information such as job details information 32, table information 33, log information 34 and trouble reproducing information (problem reproducing information) 35 is stored in the storage device 26 besides the program 31. Even when the image processing device 2 reboots, the information is kept being stored in the storage device 26.

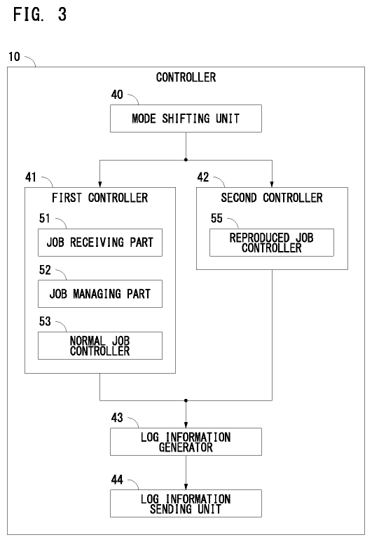

A functional structure of the controller 10 is explained next. FIG. 3 illustrates an example of the functional structure of the controller 10 according to one or more embodiments. The CPU 10a of the controller 10 executes the program 31 so that the controller 10 serves as a mode shifting unit 40, a first controller 41, a second controller 42, a log information generator 43 and a log information sending unit 44.

The mode shifting unit 40 controls the operation mode of the image processing device 2 to be either the normal job mode or the reproducing and verifying mode. More specifically, when no trouble occurs in the image processing device 2, the mode shifting unit 40 sets the operation mode to the normal job mode. As a result, the image processing device 2 is enabled to process the job given by the user.

On the other hand, some kind of trouble may occur in the image processing device 2. In such a case, the mode shifting unit 40 shifts the operation mode to the reproducing and verifying mode only when the image processing device 2 in the normal job mode is not used by the user for more than the predetermined period of time and the trouble code is added to the job details information 32 stored in the storage device 26.

The mode shifting unit 40, however, does not always shift to the reproducing and verifying mode if the trouble code is added to the job details information 32. To be more specific, the mode shifting unit 40 analyzes the trouble code, and determines whether or not to shift to the reproducing and verifying mode according to the trouble code. The trouble occurs in the image processing device 2, for instance, may be a running-out of papers or an out-of-toner. In this case, the mode shifting unit 40 determines it is not necessary to shift to the reproducing and verifying mode. A cause of the trouble relating to consumables such as the running-out of papers or the out-of-toner is clear, and it is not necessary to verify by reproducing the trouble. The trouble of a low occurrence frequency may occur in the image processing device 2. In this case, the mode shifting unit 40 determines that it is necessary to shift to the reproducing and verifying mode.

The first controller 41 and the second controller 42 alternatively become operative in the controller 10 according to the operation mode of the image processing device 2. More specifically, the first controller 41 becomes operative when the image processing device 2 is in the normal job mode. The first controller 41 controls processing of the job given by the user. The second controller 42 becomes operative when the image processing device 2 is in the reproducing and verifying mode. The second controller 42 controls processing of the reproduced job that reproduces the job which was being processed when the trouble occurred.

The first controller 41 includes a job receiving part 51, a job managing part 52 and a normal job controller 53. The job receiving part 51 receives the normal job given by the user when the image processing device 2 is in the normal job mode. Once the job is received by the job receiving part 51, the job managing part 52 becomes operative. The job managing part 52 generates the job details information 32 relating to the job received by the job receiving part 51. The job managing part 52 then stores the generated job details information 32 in the storage device 26 and manages. The job managing part 52 updates the job details information 32 as required in accordance with the job processing status.

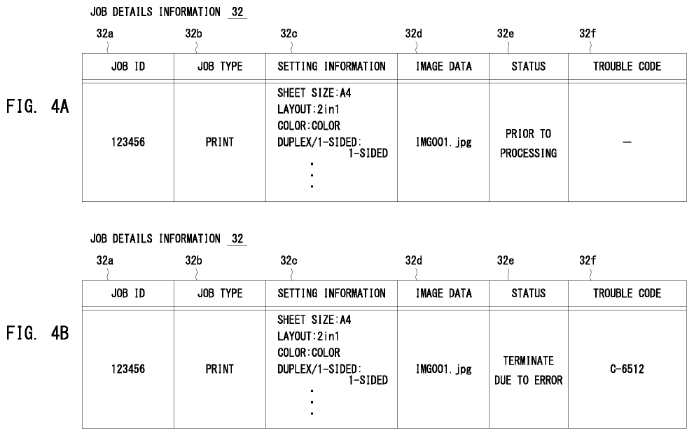

FIGS. 4A and 4B illustrate an example of the job details information 32 according to one or more embodiments. The job details information 32 includes information such as a job ID 32a, a job type 32b, setting information 32c, image data 32d, a status 32e and a trouble code 32f. When the job is received by the job receiving part 51, the job managing part 52 generates the job details information 32 as illustrated in FIG. 4A and stores in the storage device 26. The job managing part 52, for example, applies a unique identification number to a new job received by the job receiving part 51, and stores the identification number as an item of the job ID 32a. The job managing part 52 analyzes the new job, and stores information based on an analysis result as the item corresponding to each of the job type 32b, the setting information 32c and the image data 32d. If the new job is the print job, the image data included in the print job is stored as the item of the image data 32d. If the new job is the scan job or the copy job, no image data is included in the new job. The job managing part 52 then leaves the item of the image data 32d blank at the receipt of the job. Once the image data is generated after the scanner section 24 reads the document, the job managing part 52 stores the image data as the item of the image data 32d. The job managing part 52 also stores the status of the job as the item of the status 32e. If it is prior to the processing of the job, “prior to processing” is stored as the item of the status 32e. If it is during the processing of the job, “during processing” is stored as the item of the status 32e. When the job is normally complete without occurrence of the trouble during the processing of the job given by the user, the job managing part 52 deletes the job details information 32 corresponding to the job from the storage device 26.

Some kind of trouble may occur during the processing of the job while the image processing device 2 is in the normal job mode and the job may be terminated due to an error because of the trouble. In this case, as illustrated in FIG. 4B, the job managing part 52 stores “terminate due to error” as the item of the status 32e of the job details information 32. When the trouble occurs during the processing of the job, the job managing part 52 identifies the trouble, and stores the trouble code corresponding to the trouble as the item of the trouble code 32f. The job managing part 52 continues to store the job details information 32 to which the trouble code is added in the storage device 26.

The normal job controller 53 is the first job controller, and controls processing of a job given by the user to the image processing device 2 in the normal job mode. The job given by the user may be the print job, for instance. In this case, the normal job controller 53 stores the image data included in the job in the image memory 13, and brings the print controller 21 into operation to produce the printed output after enabling the output image processor 15 to apply the image processing.

The job given by the user may be the scan job, for instance. In this case, the normal job controller 53 brings the scanner controller 23 into operation to read the document placed by the user, and stores the image data output from the scanner controller 23 in the image memory 13. The normal job controller 53 then brings the input image processor 14 into operation to apply the image processing and output the image data to a destination which is designated by the user.

When the job given by the user is the copy job, the normal job controller 53 performs the controls of the scan job and the print job one after the other as described above so that it may control processing of the copy job.

The trouble such as a hardware error or a software error may occur in the image processing device 2 while the job is being processed by the normal job controller 53 in the normal job mode. In this case, the trouble code corresponding to the trouble is added to the job details information 32 by the job managing part 52 as described above. The stored job details information 32 to which the trouble code is added remains in the storage device 26. The mode shifting unit 40 refers to the table information 33 based on the trouble code added to the job details information 32, and determines whether or not to shift to the reproducing and verifying mode according to the trouble code.

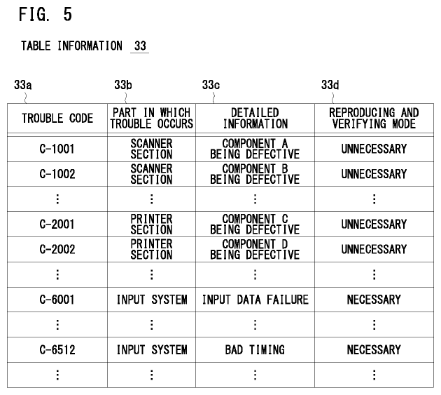

FIG. 5 illustrates an example of the table information 33 according to one or more embodiments. A trouble code 33a, a part in which trouble occurs 33b, trouble detailed information 33c and a reproducing and verifying mode 33d corresponding to each other is stored as the table information 33. Detailed information about a part in which the trouble occurs is stored as the part in which trouble occurs 33b. Detailed information about a type of the trouble is stored as the detailed information 33c. Information about whether or not to shift to the reproducing and verifying mode is stored as the reproducing and verifying mode 33d. The trouble occurs in the image processing device 2 may be due to a defective hardware component, for example, and it may be clear that the trouble can be resolved by replacing the defective component. In such a case, it is not necessary to reproduce the same trouble so that “unnecessary” is stored in advance as the reproducing and verifying mode 33d. If, on the other hand, it is clear that the cause of the trouble occurs in the image processing device 2 is not due to a certain defective hardware component, the cause has to be identified by reproducing the trouble. Information, “necessary,” is then stored in advance as the reproducing and verifying mode 33d. In the example of FIG. 5, when information that is “input data failure” or “bad timing” is stored as the detailed information 33c, it is necessary to shift to the reproducing and verifying mode. The information of “input data failure” means that some kind of failure can be found in the image data obtained for the processing of the job. The cause of the failure of the image data is, however, not clear. The information of “bad timing” means that the timing of the input and output of a control signal to control the processing of the job is bad. This bad timing tends to occur when multiple jobs are processed by the image processing device 2. Information showing whether or not to shift to the reproducing and verifying mode according to the type of the trouble is stored in advance as the table information 33.

The mode shifting unit 40 refers to the information stored as the reproducing and verifying mode 33d in the table information 33 based on the trouble code added to the job details information 32, and decides whether or not it is necessary to shift to the reproducing and verifying mode. When deciding to shift to the reproducing and verifying mode, the mode shifting unit 40 shifts the operation mode to the reproducing and verifying mode only if the image processing device 2 in the normal job mode is not being used by the user for more than the predetermined period of time. As a result, the second controller 42 then becomes operative in the controller 10 of the image processing device 2.

The second controller 42 includes a reproduced job controller 55. The reproduced job controller 55 is the second job controller that controls the processing of the reproduced job in the reproducing and verifying mode. While the image processing device 2 is in the reproducing and verifying mode, the reproduced job controller 55 repeatedly processes the reproduced job until an occurrence of the same trouble as the trouble code added to the job details information 32 is detected. For repeatedly processing the reproduced job, the reproduced job controller 55 may process the reproduced job under the same condition as the previous time, or may process the reproduced job under different condition from the previous time.

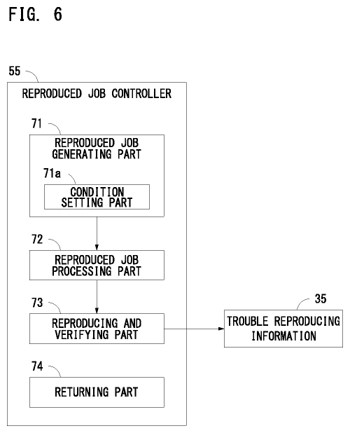

FIG. 6 illustrates a block diagram showing an example of a detailed functional structure of the reproduced job controller 55 according to one or more embodiments. The reproduced job controller 55 includes a reproduced job generating part 71, a reproduced job processing part 72, a reproducing and verifying part 73 and a retuning part 74.

The reproduced job generating part 71 reads the job details information 32 to which the trouble code is added from the storage device 26, and generates a reproduced job corresponding to the job which was being processed at the occurrence of the trouble based on the job details information 32.

It is assumed, for example, that the job details information 32 is about the scan job. In this case, the reproduced job generating part 71 generates a job that brings the scanner controller 23 into operation to enable the scanner section 24 to read the document as the reproduced job based on the job details information 32. The reproduced job corresponding to the scan job replaces the image data obtained by the scanner section 24 to the image data included in the job details information 32 when the image data is obtained by the reading operation of the document by the scanner section 24, and applies a variety of later processing including the image processing to the replaced image data. More specifically, the reproduced job uses the image data the same as that used at the occurrence of the trouble to apply the image processing so that reproducibility can be enhanced. Also, setting values stored as the setting information 32c in the job details information 32 are applied to a variety of setting items of the reproduced job. The reproduced job, however is the job to verify that the same trouble occurs during the processing of the job in the image processing device 2 so that the image data is not output to a device such as an external device after the processing by the image processing device 2 is complete.

It is assumed, for example, that the job details information 32 is about the print job. In this case, the reproduced job generating part 71 generates the reproduced job based on the image data included in the job details information 32. The reproduced job of the print job uses the image data included in the job details information 32 to apply process including the image processing. The reproduced job of the print job does not output the image data based on which the printed output may be produced to the print controller 21. The process that actually drives the printer section 22 is not performed. This is to prevent consumption of consumables such as a printing sheets and toner by the reproduced job.

The reproduced job generating part 71 includes a condition setting part 71a. The condition setting part 71a sets conditions for processing the reproduced job. The condition setting part 71a, for example, sets a condition to have the same settings as that at the occurrence of the trouble based on the setting information 32c added to the job details information 32.

The condition setting part 71a is also enabled to set the other conditions except for the setting information 32c. More specifically, the condition setting part 71a determines the condition for processing the reproduced job based on the trouble code added to the job details information 32, and sets the determined condition with the reproduced job. As one of examples, the condition setting part 71a is enabled to set a condition relating to input and output timing of the control signal. The condition setting part 71a refers to the table information 33 based on the trouble code added to the job details information 32 so that it may identify the trouble occurred in the image processing device 2. The trouble occurred in the image processing device 2 may be due to bad timing. In such a case, the condition setting part 71a sets the condition relating to input and output timing of the control signal for processing the reproduced job.

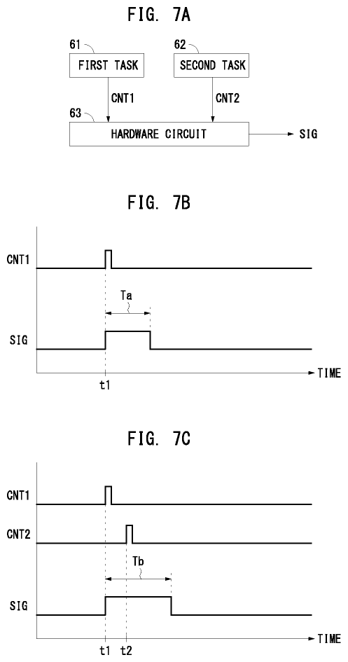

FIGS. 7A, 7B and 7C illustrate input and output timings of the control signal according to one or more embodiments. As illustrated in FIG. 7A, it is assumed, for example, that a first task 61 and a second task 61 are started at the same time in the image processing device 2, and control signals CNT1 and CNT2 are output from the respective first task 61 and second task 62 to a hardware circuit 63. This situation may be happened when multiple jobs are processed by the image processing device 2. More specifically, the first task 61 is started in response to the first job and the second task 62 is started in response to the second job so that the first task 61 and the second task 62 are started at the same time. Each of the control signals CNT1 and CNT2 is output from the corresponding first task 61 and second task 62 to the hardware circuit 63. The hardware circuit 63 outputs a signal SIG to a later stage circuit based on the control signal CNT1 and the control signal CNT2 output from the first task 61 or the second task 62. The hardware circuit 63 starts outputting the signal SIG at a timing of inputting either of the control signal CNT1 or CNT2, and keeps outputting for a predetermined period of time Ta. In response to inputting the control signal CNT1 at a timing t1 as illustrated in FIG. 7B, for example, the hardware circuit 63 keeps outputting the signal SIG for the predetermined period of time Ta from the timing t1. In the aforementioned circuit structure, in response to inputting the signal SIG output for the predetermined period of time Ta, the later stage circuit of the hardware circuit 63 determines the input signal SIG is the normal signal SIG, and performs processing corresponding to the signal SIG. On the other hand, in response to inputting the signal SIG which is kept being output for more than the predetermined period of time Ta from the hardware circuit 63, the later stage circuit determines the input signal SIG as an abnormal signal, and sometimes notifies an occurrence of a trouble.

FIG. 7C illustrates an example where a trouble occurs due to the two control signals CNT1 and CNT2. In the aforementioned circuit structure, after the first task 61 outputs the control signal CNT1 at the timing t1, the second task 62 may output the control signal CNT2 at timing t2 which is before the elapse of the predetermined period of time Ta. In this case, the hardware circuit 63 starts an operation to output the signal SIG for the predetermined period of time Ta based on the control signal CNT1, and an operation to output the signal SIG again for the predetermined period of time Ta based on the control signal CNT2. A period Tb for which the signal SIG is output from the hardware circuit 63 then extends the predetermined period of time Ta. The later stage circuit then determines the signal SIG is the abnormal signal, and a trouble occurs. As a result, the information “bad timing” is stored as the detailed information 33c in the job details information 32.

For setting the reproduced job in the above-described case, the condition setting part 71a determines a timing when the second task 62 outputs the control signal CNT2 after the first task 61 outputs the control signal CNT1, and sets the condition for processing the reproduced job based on the determination result. Hence, when the reproduced job is repeatedly processed by the image processing device 2, the condition setting part 71a is enabled to change the timing t1 at which the first task 61 outputs the control signal CNT1 and the timing t2 at which the second task 62 outputs the control signal CNT2. As a result, a reproducing rate of troubles can be increased.

The reproduced job processing part 72 controls processing of the reproduced job. More specifically, the reproduced job processing part 72 controls to bring the image memory 13, the input image processor 14, the output image processor 15, the print controller 21, the scanner controller 23, the scanner section 24 and the fax section 25 into operation based on the reproduced job. The reproduced job processing part 72, however, does not bring the printer section 22 into operation at processing of the reproduced job, which is different from the normal job controller 53. When the reproduced job is processed by the image processing device 2, consumables such as the sheets and/or toner is not consumed.

The reproducing and verifying part 73 verifies whether or not the same trouble occurs during processing of the reproduced job. To be more specific, when a trouble such as a hardware error or a software error occurs during processing of the reproduced job, the reproducing and verifying part 73 identifies the trouble code corresponding to the trouble. The reproducing and verifying part 73 determines if the identified trouble code is the one the same as that added to the job details information 32 so that it determines whether or not the same trouble has reproduced. As a result, when occurrence of the same trouble as the trouble code added to the job details information 32 is detected during processing of the reproduced job, the reproducing and verifying part 73 generates the trouble reproducing information 35 and stores the generated trouble reproducing information 35 in the storage device 26. Conditions for processing of the reproduced job (for instance, job settings information and/or input and output timing) are stored as the trouble reproducing information 35.

The reproducing and verifying part 73 stores the trouble reproducing information 35 in the storage device 26 so that the trouble reproducing information 35 may be referred when the normal job is processed by the image processing device 2 in the normal job mode thereafter. To be more specific, if the trouble reproducing information 35 is stored in the storage device 26 at the time of processing of the normal job by the image processing device 2 in the normal job mode, the first controller 41 refers to the trouble reproducing information 35. The first controller 41 controls processing of the normal job with avoiding the conditions stored as the trouble reproducing information 35 so that it may prevent occurrence of the same trouble in the image processing device 2.

After verifying that the same trouble occurs again during processing of the reproduced job, the reproducing and verifying part 73 notifies the mode shifting unit 40 that the verification of reproducing the trouble is complete. The mode shifting unit 40 then terminates the reproducing and verifying mode, and shifts to the normal job mode.

The user operation to the operational panel 11 may be detected or the job may be received via the communication interface 12 while the image processing device 2 is in the reproducing and verifying mode. In this case, the mode shifting unit 40 forcefully terminates the reproducing and verifying mode, and shifts to the normal job mode. When the user tries to use the image processing device 2 while the operation mode of the image processing device 2 is the reproducing and verifying mode, the operation mode is shifted to the normal job mode, and the image processing device 2 in the normal job mode is enabled to process the job given by the user preferentially.

As a trouble occurs during processing of the reproduced job, the later processing on the reproduced job may be frozen. In such a case, the retuning part 74 becomes operative in the reproduced job controller 55. The retuning part 74 automatically reboots the image processing device 2 and returns it from the trouble. More specifically, the retuning part 74 outputs the rebooting instruction to the power controller 16 so that it enables the image processing device 2 to automatically reboot. As a result of this reboot, the image processing device 2 is enabled to automatically return from the frozen state due to the trouble.

Referring back to FIG. 3, the log information generator 43 generates the log information 34 when the normal job is processed by the first controller 41 or the reproduced job is processed by the second controller 42. While the normal job is processed by the first controller 41, the log information generator 43 generates the basic log information 34 without generating the detailed log information 34. To be more specific, while the image processing device 2 is in the normal job mode, the log information generator 43 generates the log information 34 only including basic information. The basic information is that a date and time of receipt of the job, a date and time of start of processing of the job, a job type, a date and time of completion of processing of the job and information showing whether or not the job complete normally. This prevent a decrease in job processing efficiency due to the generation of the log information 34 by the log information generator 43 may be prevented while the image processing device 2 is in the normal job mode. The log information generator 43, however, does not have to generate the log information 34 while the image processing device 2 is in the normal job mode.

On the other hand, the log information generator 43 generates more detailed log information 34 than the basic log information when the reproduced job is processed by the second controller 42. To be more specific, while the image processing device 2 is in the reproducing and verifying mode, the log information generator 43 generates the log information 34 including not only the basic information but also detailed information showing timings when the control signal or the image data is output to each part. The basic information is that the date and time of receipt of the job, the date and time of start of processing of the job, the job type, the date and time of completion of processing of the job and information showing whether or not the job complete normally. As the reproduced job is not the job given by the user, it is not a big problem to have a decrease in the reproduced job processing efficiency. The generation of the detailed log information 34 enables detailed analysis how each part operates at the processing of the reproduced job at what timing. This is helpful for clearing up the cause of the trouble.

The log information sending unit 44 sends the log information 34 generated by the log information generator 43 during processing of the reproduced job to the server 3. The log information sending unit 44 sends the log information 34 to the server 3 so that a person such as a developer is allowed to identify the hardware or the software in which the trouble occurs.

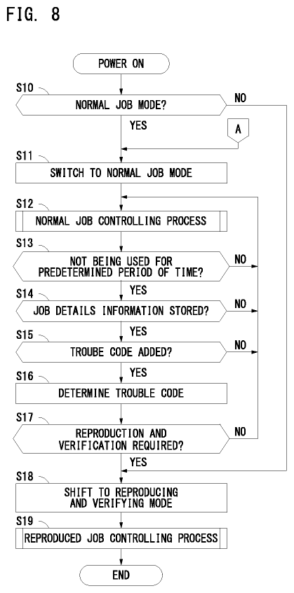

A process sequence performed at the image processing device 2 having above-described structure is explained next. FIG. 8 illustrates a flow diagram explaining an exemplary procedure of a main process performed at the image processing device 2 according to one or more embodiments. This process is started when the image processing device 2's power switch is turned on. Upon start of the process, the image processing device 2 determines if it is in the normal job mode (step S10). When the operation mode at previous termination of power is the normal job mode, the image processing device 2 determines as YES in step S10. When the operation mode at previous termination of power is the reproducing and verifying mode, the image processing device 2 determines as NO in step S10.

When being in the normal job mode (when a result of step S10 is YES), the image processing device 2 shifts the operation mode to the normal job mode (step S11), and performs a normal job controlling process (step S12). The normal job controlling process is performed when the above-described first controller 41 becomes operative to process the normal job.

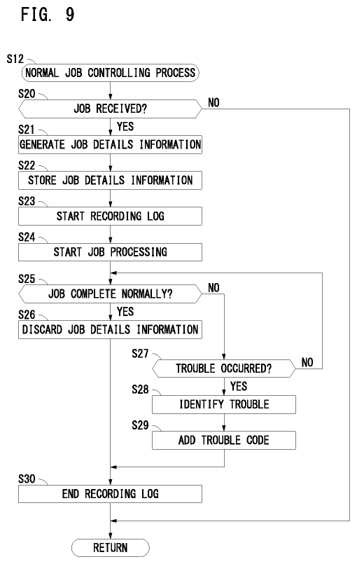

FIG. 9 illustrates a flow diagram explaining in detail an exemplary procedure of the normal job controlling process (step S12) according to one or more embodiments. Upon start of the normal job controlling process, the image processing device 2 determines whether or not the job given by the user is received (step S20). When the job is not received (when a result of step S20 is NO), the image processing device 2 completes the normal job controlling process. When the job is received (when a result of step S20 is YES), the image processing device 2 generates the job details information 32 corresponding to the job (step S21), and stores the generated job details information 32 in the storage device 26 (step S22). The image processing device 2 then brings the log information generator 43 into operation to start recording the log information 34 (step S23). The image processing device 2 is in the normal job mode, so it records only the basic information. The image processing device 2 starts processing the job given by the user (step S24).

The image processing device 2 determines if the job is complete normally (step S25). When the job is complete normally (when a result of step S25 is YES), the image processing device 2 discards the job details information 32 in the storage device 26 (step S26). When the job is not complete normally (when a result of step S25 is NO), the image processing device 2 determines if the trouble occurs (step S27). The trouble may not occur (when a result of step S27 is NO). In such a case, the image processing device 2 is put into a waiting state until the job is complete normally or the trouble occurs.

The trouble may occur during processing of the job (when a result of step S27 is YES). In this case, the image processing device 2 identifies the trouble (step S28), and adds the trouble code corresponding to the trouble to the job details information 32 (step S29). The job details information 32 is then kept being stored. The image processing device 2 ends the operation to record the log (step S30). As described above, the normal job controlling process (step S12) ends.

Referring back to FIG. 8, after ending the normal job controlling process (step S12), the image processing device 2 determines whether or not the image processing device 2 is not being used for the predetermined period of time (step S13). If not being used for the predetermined period of time (when a result of step S13 is YES), the image processing device 2 determines if the job details information 32 is stored in the storage device 26 (step S14). The job details information 32 may be stored in the storage device 26 (when a result of step S14 is YES). In this case, the image processing device 2 determines whether or not the trouble code is added to the job details information 32 (step S15). If the trouble code is added (when a result of step S15 is YES), the image processing device 2 determines the trouble code (step S16). As a result of the determination, the trouble code may correspond to the trouble that requires reproduction and verification (when a result of step S17 is YES). The image processing device 2 then shifts the operation mode to the reproducing and verifying mode (step S18). The image processing device 2 may be used in the predetermined period of time (when a result of S13 is NO), the job details information 32 may not be stored in the storage device 26 (when a result of S14 is NO), the trouble code may not be added to the job details information 32 (when a result of S15 is NO), or no trouble that requires the reproducing and verifying may occur (when a result of S17 is NO). In such a case, the process performed by the image processing device 2 returns to step S12 to wait for the job given by the user.

After shifting to the reproducing and verifying mode, the image processing device 2 performs a reproduced job controlling process (step S19). The reproduced job control process is performed when the above-described second controller 42 becomes operative to process the reproduced job.

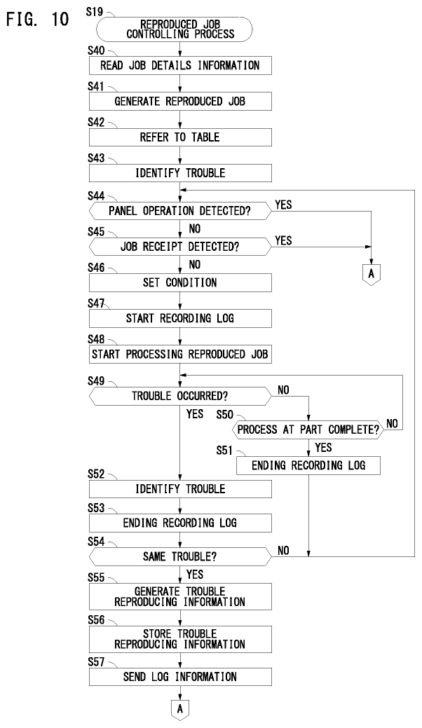

FIG. 10 illustrates a flow diagram explaining in detail an exemplary procedure of the reproduced job controlling process (step S19) according to one or more embodiments. Upon start of the reproduced job controlling process, the image processing device 2 reads the job details information 32 in the storage device 26 (step S40), and generates the reproduced job based on the job details information 32 (step S41). The image processing device 2 then refers to the table information 33 based on the trouble code added to the job details information 32 (step S42), and identifies the trouble (step S43). In one or more embodiments the part in which the trouble occurs is identified in advance by the image processing device 2.

The image processing device 2 determines if the user operation to the operational panel 11 is detected (step S44). The user operation may be detected (when a result of step S44 is YES). In this case, the process performed by the image processing device 2 moves on to step S1l of FIG. 8. In detail, the image processing device 2 terminates the reproducing and verifying mode, and shifts to the normal job mode. When the user operation is not detected (when a result of step S44 is NO), the image processing device 2 determines whether or not the job given by the user is received (step S45). When the job given by the user is received (when a result of step S45 is YES), the process performed by the image processing device 2 moves on to step S11 of FIG. 8. In also this case, the image processing device 2 terminates the reproducing and verifying mode, and shifts to the normal job mode.

When the job by the user is not received (when a result of S45 is NO), the image processing device 2 sets the condition for processing the reproduced job (step S46). The same condition as that for the previous processing may be applied, or a different condition may be applied. The image processing device 2 then brings the log information generator 43 into operation to start the operation to record the log information 34 (step S47). As the image processing device 2 is in the reproducing and verifying mode, the image processing device 2 starts recording the log information 34 including not only the basic information but also the detailed information. The image processing device 2 starts processing the reproduced job (step S48).

After starting processing of the reproduced job, the image processing device 2 determines if the trouble occurs (step S49). The processing of the reproduced job may be carried out without the occurrence of the trouble (when a result of S49 is NO). The image processing device 2 then determines the process at the part in which the trouble occurs is complete (step S50). It is assumed, for example, that the reproduced job corresponds to the copy job, and brings the scanner section 24, the image memory 13, the input image processor 14, the output image processor 15 and the printer section 22 into operation one after the other. In such a case, the image processing device 2 determines whether or not the whole operation at the input image processor 14 is complete if the part in which the trouble occurs is a hardware of the input image processor 14. When the whole operation at the part in which the trouble occurs is not complete (when a result of S50 is NO), the process performed by the image processing device 2 returns to step S49. The whole operation at the part in which the trouble occurs may be complete (when a result of step S50 is YES). In this case, the image processing device 2 forcefully terminates processing of the reproduced job, and terminates the operation to record the log information 34 (step S51). To be more specific, an object of the reproduced job is to reproduce and verify the same trouble. If the whole process carried out by the part in which the trouble occurred is complete, there is no possibility of having the same trouble in the later process. Therefore, processing of the reproduced job is forcefully terminated. As described above, processing of the reproduced job is forcefully terminated so that the number of processing of the reproduced jobs may be efficiently increased. After forcefully terminating processing of the reproduced job, the image processing device 2 returns to step S44 to repeatedly perform the above-described process.

The trouble may occur during processing of the reproduced job (when a result of step S49 is YES). In this case, the image processing device 2 identifies the trouble (step S52), and terminates the operation to record the log information 34 (step S53). The log information 34 thereby generated is stored in the storage device 26. The image processing device 2 determines if the trouble occurred during processing of the reproduced job is the same trouble as that occurred at processing of the normal job (step S54). If the troubles are the same, (when a result of step S54 is YES), the image processing device 2 generates the trouble reproducing information 35 based on the information such as the condition applied at processing of the reproduced job (step S55), and stores the generated trouble reproducing information 35 in the storage device 26 (step S56). The image processing device 2 then sends the log information 34 stored in step S53 to the server 3 (step S57). As a result, the server 3 is enabled to obtain the detailed log information 34 recorded at the occurrence of the trouble in the image processing device 2. The process performed by the image processing device 2 then moves to step S11 of FIG. 8. Also in this case, the image processing device 2 terminates the reproducing and verifying mode, and shifts to the normal job mode.

If the trouble occurred during processing of the reproduced job is not the same as the trouble occurred at processing of the normal job (when a result of step S54 is NO), the process performed by the image processing device 2 returns to step S44 to repeatedly perform the above-described process. Hence, processing of the reproduced job is repeatedly performed until the same trouble occurs.

When the later process on the reproduced job is frozen due to the trouble occurred during processing of the reproduced job, the retuning part 74 automatically reboots the image processing device 2 as described above so that the image processing device 2 may be recovered from the trouble.

In the above-described procedure of the process, the example where the process to return the operation mode from the reproducing and verifying mode to the normal mode is performed in response to a detection of the user operation to the operational panel 11 in the reproducing and verifying mode. It, however, does not mean that the user always gives a job even when the user operates the operational panel 11. The image processing device 2 may return the operation mode to the normal job mode from the reproducing and verifying mode at a timing when the job start instruction is given by the user who is using the operational panel 11.

As described above, the image processing device 2 of one or more embodiments has two modes, the normal mode and the reproducing and verifying mode, as its operation mode. When the trouble occurs in the image processing device 2 in the normal job mode, the image processing device 2 automatically shifts the operation mode to the reproducing and verifying mode, and automatically processes the reproduced job so that it may perform the self-diagnostic of the trouble.

The trouble may occur accidentally due to the external cause unique to a client environment (including, for example, temperature, humidity, power condition and/or surrounding electrostatic environment). Even in this case, the image processing device 2 performs the self-diagnostic in the client environment so that the same trouble may be reproduced. This can clear up the cause of the trouble at a relatively early stage.

The image processing device 2 shifts to the reproducing and verifying mode and performs the self-diagnostic of the trouble while it is not being used by the user. This may avoid a situation that the user is not allowed to use as a consequence of the self-diagnostic, and does not have decrease in the convenience of the image processing device 2.

Although the embodiments of the present invention have been described and illustrated in detail, it is clearly understood that the same is by way of illustration and example only and not limitation, the scope of the present invention should be interpreted by terms of the appended claims.

### (Modifications)

While embodiments of the present invention have been described above, the present invention is not limited to the above-described embodiments. Various modifications may be applied to one or more embodiments of the present invention.

In the above-described embodiments, for example, the image processing device 2 automatically shifts to the reproducing and verifying mode. The shift to the reproducing and verifying mode from the normal mode is not always made automatically. When the trouble code is added to the job details information 32 stored in the storage device 26 and the image processing device 2 determines it is necessary to shift to the reproducing and verifying mode, for example, the image processing device 2 may display a screen to shift to the reproducing and verifying mode on the display unit 11a of the operational panel 11. The image processing device 2 may shift the operation mode to the reproducing and verifying mode from the normal mode when the user performs an operation to shift to the reproducing and verifying mode. Even in this case, however, the image processing device 2 may prioritize processing of the job given by the user.

The program 31 of one or more embodiments executed by the CPU 10a is installed in advance in the image processing device 2. The program 31 does not always have to be installed in advance in the image processing device 2. The program 31 may be the target of trading independently. The program 31 then may be provided with the image processing device 2 over an internet in a manner that enables the user to download, or may be provided with the image processing device 2 in a manner that is recorded on a computer readable recording medium such as a CD-ROM or a USB memory.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. An image processing device that has a normal job mode and a reproducing and verifying mode comprises:
a hardware processor that:
receives a job;
controls processing of the received job in the normal job mode;
generates job details information relating to the received job to be processed,
when a problem occurs during processing of the job, adds a problem code corresponding to the problem to the job details information to manage the job details information;
shifts to the reproducing and verifying mode from the normal job mode only if the problem code is added to the job details information; and
generates a reproduced job based on the job details information added with the problem code and controls processing of the reproduced job in the reproducing and verifying mode.

2. The image processing device according to claim 1, wherein
in the reproducing and verifying mode, the hardware processor repeatedly processes the reproduced job until an occurrence of a problem that is the same as the problem code added to the job details information is detected.

3. The image processing device according to claim 2, wherein
the hardware processor processes again the reproduced job under a same condition as a previous processing when the same problem as the problem code added to the job details information is not detected during the processing of the reproduced job.

4. The image processing device according to claim 2, wherein
the hardware processor processes again the reproduced job under a different condition from a previous processing when the same problem as the problem code added to the job details information is not detected during the processing of the reproduced job.

5. The image processing device according to claim 3, wherein
the hardware processor determines the condition for processing the reproduced job based on the problem code added to the job details information.

6. The image processing device according to claim 3, wherein
the hardware processor manages the condition applied to the processing of the reproduced job, as problem reproducing information, when the same problem as the problem code added to the job details information is detected during the processing of the reproduced job.

7. The image processing device according to claim 6, wherein
the hardware processor controls the processing of the job under a different condition from the condition stored as the problem reproducing information when the processing of the job is controlled in the normal job mode.

8. The image processing device according to claim 1, wherein
the hardware processor further:
generates log information during the processing of the reproduced job; and
sends the obtained log information to an external server.

9. The image processing device according to claim 8, wherein
the hardware processor generates the log information even when the job is processed in the normal job mode and generates the log information in the reproducing and verifying mode in more detail than when the log information is generated in the normal job mode.

10. The image processing device according to claim 1, wherein
the hardware processor discards the job details information that corresponds to the job when the processing of the job is completed without an occurrence of the problem.

11. The image processing device according to claim 1, wherein
the hardware processor further automatically reboots and recovers from the problem when the problem occurs during processing of said reproduced job.

12. The image processing device according to claim 1, wherein
the job details information includes image data used in the processing of the job, and
the hardware processor controls the processing of the reproduced job using the image data.

13. The image processing device according to claim 12, further comprising:
a scanner that reads a document and generates image data;
a scanner controller that drives the scanner and obtains the image data from the scanner; and
an image processor that applies an image processing to the image data, wherein
the hardware processor replaces the image data from the scanner controller with the image data included in the job details information when the reproduced job is a job accompanying a reading operation of the document.

14. The image processing device according to claim 1, further comprising:
a printer that produces a printed output; and
a print controller that drives the printer based on input image data, wherein
the hardware processor does not output the input image data to the print controller during the processing of the reproduced job when the reproduced job is a job accompanying a process to produce the printed output.

15. The image processing device according to claim 1, further comprising:
a storage that stores table information that contains information on a part where the problem occurs and the problem code corresponding to the problem, wherein
the hardware processor refers to the table information based on the problem code added to the job details information, identifies the part where the problem occurs, and terminates the processing of the reproduced job when completion of the processing at the identified part is detected during the processing of the reproduced job.

16. The image processing device according to claim 1, further comprising:
an operation panel that receives a user operation, wherein
the hardware processor automatically shifts to the reproducing and verifying mode from the normal job mode when the problem code is added to the job details information and the user operation on the operation panel is not detected for more than a predetermined period of time.

17. The image processing device according to claim 16, wherein
the hardware processor shifts to the normal job mode from the reproducing and verifying mode when the user operation on the operation panel is detected in the reproducing and verifying mode.

18. The image processing device according to claim 1, wherein
the hardware processor shifts to the normal job mode from the reproducing and verifying mode when the job is received in the reproducing and verifying mode.

19. The image processing device according to claim 1, wherein
the hardware processor does not shift to the reproducing and verifying mode when the problem code added to the job details information is a predetermined problem code.

20. A self-diagnostic method applied at an image processing device, the method comprising:
receiving a job;
controlling processing of the received job in a normal job mode;
generating job details information relating to the received job to be processed,
when a problem occurs during processing of the job, adding a problem code corresponding to the problem to the job details information to manage the job details information;
shifting to a reproducing and verifying mode from the normal job mode only if the problem code is added to the job details information; and
generating a reproduced job based on the job details information to which the problem code is added and controlling processing of the reproduced job in the reproducing and verifying mode.

21. A non-transitory recording medium storing a computer readable program to be executed by a hardware processor of an image processing device having a normal job mode and a reproducing and verifying mode, the hardware processor executing the computer readable program to perform:
receiving a job;
controlling processing of the received job in the normal job mode;
generating job details information relating to the received job to be processed,
when a problem occurs during processing of the job, adding a problem code corresponding to the problem to the job details information to manage the job details information;
shifting to the reproducing and verifying mode from the normal job mode only if the problem code is added to the job details information; and
generating a reproduced job based on the job details information to which the problem code is added and controls processing of the reproduced job in the reproducing and verifying mode.
